(19) United States
(12) Patent Application Publication
(10) Pub. No.: US 2003/0007293 A1
(43) Pub. Date: Jan. 9, 2003

(54) Self-regulating lubrication of ramps for disc drives

(76) Inventors: Quock Ying Ng, Singapore (SG); Pow-Hing Yong, Singapore (SG); Samuel P.H. Gan, Singapore (SG)

Correspondence Address: Shawn B Dempster, Seagate Technology LLC, Intellectual Property - SHK2LG, 1280 Disc Drive, Shakopee, MN, 55378-1863, US

(21) Appl. No.: 10/087,688

(22) Filed: Mar. 1, 2002

Related U.S. Application Data
(60) Provisional application No. 60/302,882, filed on Jul. 3, 2001.

(51) Int. Cl. G11B 5/54

(52) U.S. Cl. 360/254.8

(57) ABSTRACT

A ramp molded from a compound formulation of essentially a polymer and a liquid. The liquid is one that is chemically incompatible with the polymer, and is distributed in the polymer in the form of droplets. The lower surface tension of the liquid drives the droplets to the ramp surfaces until an equilibrium thickness of the liquid is achieved on the ramp surfaces.

### CROSS REFERENCE TO RELATED APPLICATIONS

This application claims the benefit of U.S. Provisional Application No. 60/302,882 filed Jul. 3, 2001.

### FIELD OF THE INVENTION

The present invention relates generally to disc drives. More particularly, the present invention relates to improved ramps for use in disc drives.

### BACKGROUND OF THE INVENTION

Some disc drives are designed with ramps that allow read/write heads to be parked away from a disc surface when the disc drive is not in operation. The read/write heads are mounted on a suspension from which extends a tab. As the read/write heads are moved away from the disc surface, the tab slides onto a ramp surface and lifts the read/write heads further away from the disc surface.

The tabs are typically made of stainless steel, while the ramp is made from polymers known to exhibit the desired mechanical properties of dimensional tolerance and rigidity. Unfortunately, the tribological performance of such polymers is often less than desirable. Repetitive rubbing of the tab along the ramp surface is known to cause excessive wear of the ramp, and to contribute towards particulate contamination within the disc drive enclosure. Attempts to alleviate the problem have generally centered on coating the ramp surface with lubricating substances.

Although the ramp surface may be coated with a lubricant at an appropriate stage of manufacturing the disc drive, there is yet a satisfactory solution to the problem of the lubricant wearing off in the life of the disc drive. One proposal involves fabricating the ramp with thin layers of a polytetrafluoroethylene (PTFE). As one layer of PTFE is rubbed off, an inner layer becomes exposed and provides a new surface for the tab to slide against.

At the same time, however, one must not lose sight of the importance of minimizing particulate contamination within the disc drive enclosure. Therefore, a practicable solution would require consideration of these and other varied, and sometimes conflicting, requirements.

The present invention provides a solution to this and other problems, and offers other advantages over the prior art.

### SUMMARY OF THE INVENTION

The present invention relates to ramps that provide a solution to the problems described above.

In a disc drive, there is provided a ramp molded from a compound formulation of essentially a polymer and a liquid. The liquid is one that is chemically incompatible with the polymer, and is distributed in the polymer in the form of droplets. The liquid is preferably characterized by a liquid surface tension that is lower than a polymer surface tension of the polymer. Preferably, the viscosity of the liquid is such that it facilitates travel of the droplets in the polymer. In some embodiments, the ramp surface has irregularities formed by droplets traveling to the ramp surface. The compound formulation may further include particles embedded in the polymer away from the ramp surface. Preferably, the particles are present in the compound formulation in a percentage required to provide the compound formulation with a hardness that is approximately the same as the tab hardness.

The compound formulation maintains an equilibrium thickness of the liquid on the ramp surface. When some of the liquid is removed from the ramp surface, liquid molecules from the droplets will be driven to the ramp surface to replenish the liquid on the ramp surface. A self-regulating lubrication system is thereby provided without the need for additional sensing and feed mechanisms.

These and various other features as well as advantages which characterize the present invention will be apparent upon reading of the following detailed description and review of the associated drawings.

### BRIEF DESCRIPTION OF THE DRAWINGS

FIG. 1 is an exploded perspective view of a disc drive.

FIG. 2 shows a partial side view showing tabs in engagement with ramp surfaces.

FIG. 3 is a top view of a disc with a ramp at its inner diameter.

FIG. 4 is a partial top view of a disc with a ramp at its outer diameter.

FIG. 5 is a schematic diagram of a compound formulation according to an embodiment of the present invention.

### DETAILED DESCRIPTION

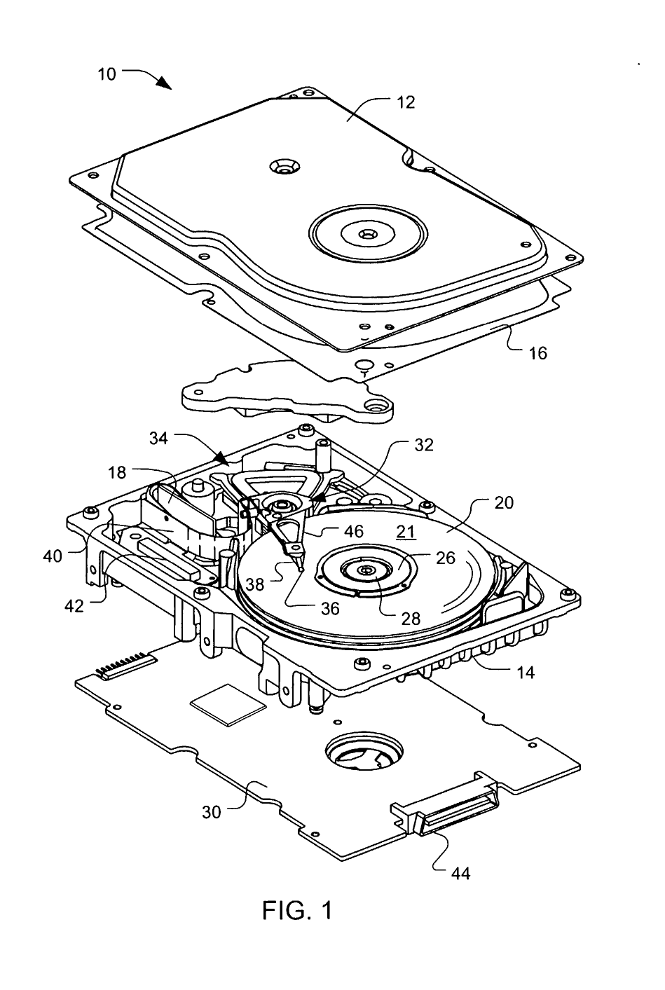

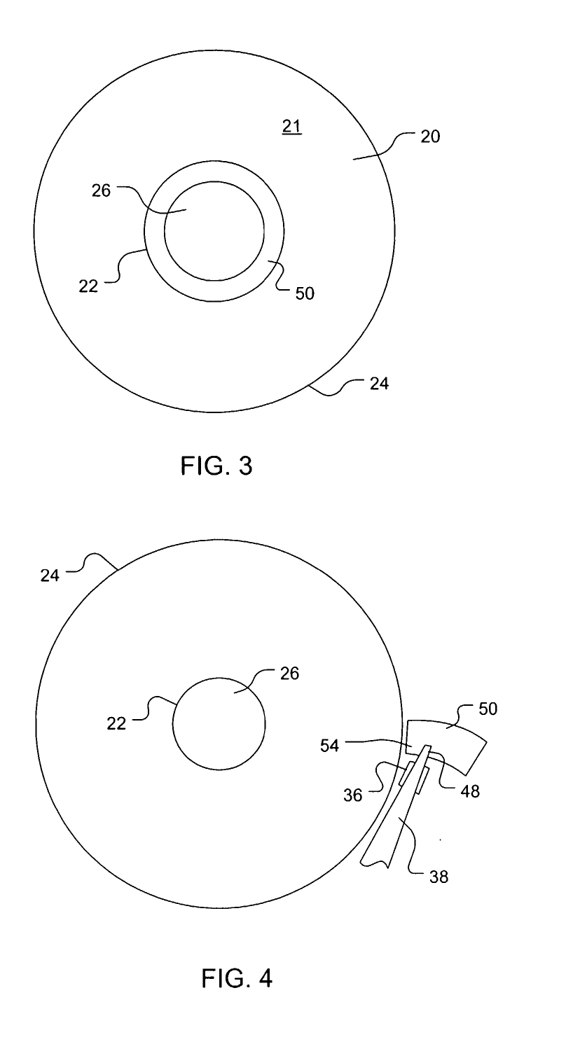

Embodiments of the present invention are described below with reference to the drawings. FIG. 1 shows a disc drive 10, such as one in which embodiments of the present invention may be implemented. A cover 12 and a base deck 14 provide a sealed enclosure within which most of the components of the disc drive reside. Once the various components of the disc drive have been assembled and the disc drive is sealed, it is not expected that the disc drive would be opened in the course of normal usage. A gasket 16 may be located between the cover 12 and the base deck 14 to improve the seal, and filters 18 may be provided to clean the air within the disc drive enclosure. Data is stored on the disc surfaces 21 of one or more discs 20. Each disc 20 is annular, being defined by an inner diameter 22 and outer diameter 24 (FIG. 3). Each disc 20 is secured to the hub of a spindle motor 26 with the aid of a disc clamp 28, while the spindle motor 26 is in turn mounted to the base deck 14. Much of the electronic circuitry that controls disc drive operations can be found on a printed circuit board 30 that is fixed to an underside of the base deck 14 or on an actuator 32. A voice coil motor 34 energizes the actuator 32 into rotary motion controllable by the electronic circuitry such that the actuator 32 brings read/write heads 36, mounted at extremities of suspensions 38, into the desired positions. The number of read/write heads in the disc drive may be varied depending on the number of disc drive surfaces 21 that are configured for use. Circuitry runs from the read/write heads 36 and eventually to a flex cable 40 that joins an internal connector 42 in contact with the printed circuit board 30, and thus provide for data and servo signals to be transferred back and forth as required for disc drive operations. Communication between the electronic circuitry of the disc drive 10 and an external host is made possible through an external connector 44 mounted to the printed circuit board 30.

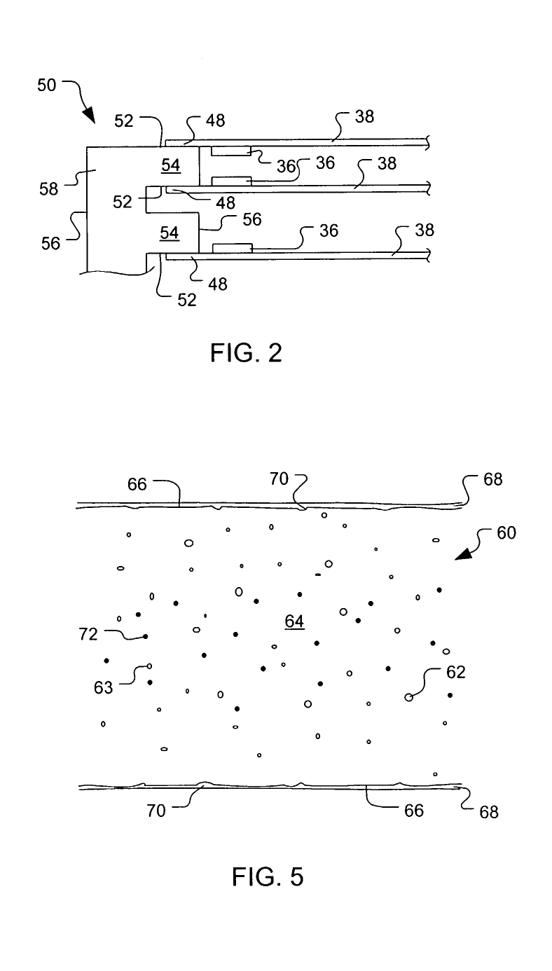

The actuator 32 includes actuator arms 46 to which are connected suspensions 38. In FIG. 2, the read/write heads 36 are shown mounted to a cantilevered suspension 38 from which also extends a tab 48 for releasably engaging a ramp surface 52 of a ramp 50. The tab 48 may be integrally formed with the suspension 38, preferably from stainless steel or from an aluminum alloy. Alternatively, it may be a separate component affixed to the suspension. The tab 48 may extend in a direction substantially parallel to the suspension 38 or in another direction as is suitable for engaging the ramp surface 52.

The ramp 50 shown in FIG. 3 is located next to the inner diameter 22 of the disc 20. The ramp 50 may be formed as an annular component that can be fastened to the hub of the spindle motor 26 and stacked alternately with the discs 20 so as to provide a ramp surface 52 for each disc surface 21 configured for use. When the read/write heads 36 are to be brought to rest in an unloading process, the actuator 32 swings the read/write heads 36 towards the inner diameter 22 of the disc 20. The tab 48 slides onto the ramp surface 52 that is preferably inclined relative to the disc surface 21 such that the read/write heads 36 are separated further away from the disc surface 21. The tab 48 eventually comes to rest on the ramp surface 52 and the read/write heads 36 are parked. When the read/write heads 36 are to be brought into operation in a loading process, the actuator 32 moves the tab 48 off the ramp surface 52 and positions the read/write heads 36 to the desired position relative to the disc surface 21.

Alternatively, as shown in FIG. 4, the ramp 50 may be located next to the outer diameter 24 of the disc 20. The ramp 50 includes one or more teeth 54, each of which has at least one ramp surface 52 leading to the outer diameter 24 of each disc surface 21 configured for use. The ramp surface 52 is preferably inclined towards the corresponding disc surface 21. The tooth 54 is further defined by other surfaces 56 (FIG. 2) such as the side surfaces. The ramp 50 includes a support 58 (FIG. 2) mounted to the base deck 14 that holds the tooth 54 at an appropriate elevation relative to the disc surfaces 21. When the read/write heads 36 are to be brought to rest in an unloading process, the actuator 32 swings the read/write heads 36 towards the outer diameter 24 of the disc 20. The tab 48 slides onto the ramp surface 52 such that the read/write heads 36 are separated further away from the disc surfaces 21. The tab 48 eventually comes to rest on the ramp surface 52 and the read/write heads 36 are parked. When the read/write heads 36 are to be brought into operation in a loading process, the actuator 32 moves the tab 48 off the ramp surface 52 and positions the read/write heads 36 to the desired position relative to the disc surfaces 21.

As illustrated schematically in FIG. 5, embodiments of the present invention provide ramps 50 molded from a compound formulation 60 having a liquid 62 distributed in a polymer 64. The liquid 62 is present as fine droplets 63, dispersed in matrix of polymer 64. The liquid 62 is chosen to be one that is chemically incompatible with the polymer 64 and with a viscosity that promotes its migration within the polymer. The liquid 62 is chosen to be one that has a boiling point and degradation temperature that is higher than the melt and molding temperatures for the polymer 64 used. In other words, the liquid 62 is stable to both the compounding and molding processes with the selected compound formulation 60.

The ramp 50 may be formed with all or most of the liquid droplets 63 embedded in the polymer 64. Following the formulation of the present invention, the liquid 62, in the form of droplets 63, will tend to diffuse to a polymer-air interface 66. As some of the liquid droplets diffuse towards the polymer-air interface, they act as a source of liquid lubricant to the ramp surfaces. The liquid is chosen such that the liquid droplets at the polymer-air interface will spread out and form a film 68 between the polymer and air.

Once an equilibrium thickness of the film 68 is reached at the polymer-air interface 66, the liquid droplets 63 still within the polymer 64 will not be driven to migrate towards the polymer-air interface 66. When some of the liquid 62 is removed from the film 68 present at the polymer-air interface, liquid droplets 63 from within the polymer 64 will be driven towards the polymer-air interface 66 to re-establish a low surface energy. Thus, as new liquid droplets 63 reach the polymer-air interface 66, the film 68 is replenished until it achieves an equilibrium thickness. In this manner, the ramp surface 52 is continuously supplied with liquid without the need for additional gadgets or complicated feed systems. The liquid is chosen for its friction reduction effects and thus provides a controlled amount of lubrication to the ramp surface 52.

Preferably, the ramp 50 is fabricated to allow for the formation of such a polymer-air interface 66 at the ramp surface 52 by allowing for migration of embedded liquid droplets to the polymer-air interfaces. According to some embodiments, the ramp 50 is fabricated to have the formation of such polymer-air interfaces 66 at the other surfaces 56 of the ramp, such as the side surfaces, in addition to the ramp surfaces. In other embodiments, the tooth 54 of the ramp is fabricated to provide such polymer-air interfaces.

Preferably, the polymer 64 and liquid 62 are chosen such that as the liquid droplets 63 reach the polymer-air interface 66, the polymer-air interface becomes “pitted” with the remnants of the “polymeric shells” of the liquid droplets, forming irregularities 70 in the ramp surface 52. In some embodiments, the remnant of the polymeric “shell” of the droplets may form a “nano-surface-roughness” on the surfaces 52,56 of the ramp. Such roughening may be desired to reduce friction as well as stiction between the tab 48 and the ramp surfaces 52.

A suitable polymer 64 may be one of aromatic polyester liquid crystalline polymers (LCP), polyphenylene sulphide, ultra high molecular weight polyethylene, polyetherimides, polyacetals, or polycarbonates. The liquid 62 may be one of perfluoropolyethers (PFPE) or hydrocarbon lubricants such as squalane.

In yet other embodiments, there may be fine particles 72 embedded within the polymer 64, preferably away from the polymer-air interface 66. The particles 72 are chosen from inorganic materials that are not expected to interact with the polymer 64 to produce outgassing. The particles 72 may be chosen from glass beads, alumina, silica, titania, clay materials (such as montmotillonite and bentonite), or fuller's earth. The particles 72 are preferably spheroidal, and preferably do not make up more than 5 to 40 wt % relative to the combined weight of the polymer, liquid and particles. The amount of particles included in the compound formulation is chosen to match the hardness of the tab 48 that comes into engagement with the ramp surface 52.

Alternatively described, one embodiment of the present invention includes a ramp (such as 50) having at least one ramp surface (such as 52) for releasable engagement with a tab (such as 48) characterized by a tab hardness. The ramp (such as 50) also includes a body molded from a compound formulation (such as 60) of essentially a polymer (such as 64) and a liquid (such as 62). The liquid (such as 62) is one that is chemically incompatible with the polymer (such as 64), and is distributed in the polymer (such as 64) in the form of droplets (such as 63).

The liquid (such as 62) may be characterized by a liquid surface tension that is lower than a polymer surface tension of the polymer (such as 64). Optionally, the viscosity of the liquid (such as 62) is such that it facilitates travel of the droplets (such as 63) in the polymer (such as 64). In some embodiments, the ramp surface (such as 52) may have irregularities (such as 70) formed by the droplets (such as 63) traveling to the ramp surface (such as 52). The compound formulation (such as 60) may further include particles (such as 72) embedded in the polymer (such as 64) away from the ramp surface (such as 52). Optionally, the particles (such as 72) are present in the compound formulation (such as 60) in a percentage required to provide the compound formulation with a hardness that is approximately the same as the tab hardness.

In another embodiment, there is provided a disc drive (such as 10) with at least one disc (such as 20), at least one read/write head (such as 36) configured to read from or write to the at least one disc (such as 20), and at least one suspension (such as 38) supporting the at least one read/write head (such as 36). Extending from the at least one suspension (such as 38) is at least one tab (such as 48) that is characterized by a tab hardness. A ramp (such as 50) is provided adjacent the at least one disc (such as 20), and the ramp (such as 50) includes at least one ramp surface (such as 52) for releasable engagement with the at least one tab (such as 48). The ramp (such as 50) also includes a body molded from a compound formulation (such as 60) of essentially a polymer (such as 64) and a liquid (such as 62). The liquid (such as 62) is one that is chemically incompatible with the polymer (such as 64), and is distributed in the polymer (such as 64) in the form of droplets (such as 63).

The liquid (such as 62) may be characterized by a liquid surface tension that is lower than a polymer surface tension of the polymer (such as 64). Optionally, the viscosity of the liquid (such as 62) is such that it facilitates travel of the droplets (such as 63) in the polymer (such as 64). In some embodiments, the ramp surface (such as 52) may have irregularities (such as 70) formed by the droplets (such as 63) traveling to the ramp surface (such as 52). The compound formulation (such as 60) may further include particles (such as 72) embedded in the polymer (such as 64) away from the ramp surface (such as 52). Optionally, the particles (such as 72) are present in the compound formulation (such as 60) in a percentage required to provide the compound formulation with a hardness that is approximately the same as the tab hardness.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular shape and structure of the ramp may vary depending on the particular disc drive configuration while maintaining substantially the same functionality without departing from the scope and spirit of the present invention. In addition, although the preferred embodiment described herein is directed to a ramp for loading/unloading a read/write head, it will be appreciated by those skilled in the art that the teachings of the present invention can be applied to other systems where a self-regulated lubricating surface may be desired, without departing from the scope and spirit of the present invention.

What is claimed is:

1. A ramp comprising:
at least one ramp surface for releasable engagement with a tab characterized by a tab hardness;
a body molded from a compound formulation consisting essentially of:
a polymer; and
a liquid that is chemically incompatible with the polymer, the liquid being in the form of droplets that are distributed in the polymer.

2. The ramp of claim 1 wherein the polymer is characterized by a polymer surface tension and wherein the liquid is further characterized by a liquid surface tension that is lower than the polymer surface tension.

3. The ramp of claim 1 wherein the liquid is further characterized by a viscosity that facilitates travel of the droplets in the polymer.

4. The ramp of claim 1 wherein the ramp surface further comprises irregularities formed by the droplets traveling to the ramp surface.

5. The ramp of claim 1 wherein the compound formulation further includes particles embedded in the polymer away from the ramp surface.

6. The ramp of claim 5 wherein the particles are present in the compound formulation in a percentage required to provide the compound formulation with a hardness approximately the same as the tab hardness.

7. A disc drive comprising:
at least one disc;
at least one read/write head configured to read from or wrote to the at least one disc;
at least one suspension supporting the at least one read/write head;
at least one tab extending from the at least one suspension, the at least one tab being characterized by a tab hardness; and
a ramp adjacent the at least one disc, comprising:
at least one ramp surface for releasable engagement with the at least one tab;
a body molded from a compound formulation consisting essentially of:
a polymer; and
a liquid that is chemically incompatible with the polymer, the liquid being in the form of droplets that are distributed in the polymer.

8. The disc drive of claim 7 wherein the polymer is characterized by a polymer surface tension and wherein the liquid is further characterized by a liquid surface tension that is lower than the polymer surface tension.

9. The disc drive of claim 7 wherein the liquid is further characterized by a viscosity that facilitates travel of the droplets in the polymer.

10. The disc drive of claim 7 wherein the ramp surface further comprises irregularities formed by the droplets traveling to the ramp surface.

11. The disc drive of claim 7 wherein the compound formulation further includes particles embedded in the polymer away from the ramp surface.

12. The disc drive of claim 11 wherein the particles are present in the compound formulation in a percentage required to provide the compound formulation with a hardness approximately the same as the tab hardness.

13. A disc drive comprising:
at least one disc;
at least one read/write head; and
means for loading/unloading the at least one read/write head to the at least one disc.

14. The disc drive of claim 13 further comprising:
a lubricant; and
means for feeding the lubricant to the means for loading/unloading.

15. The disc drive of claim 14 wherein the means for feeding the lubricant further includes means for maintaining a relatively constant thickness of lubricant on the means for loading/unloading.

16. The disc drive of claim 15 wherein the maintaining means comprises:
a body of polymer in which the lubricant is distributed, the polymer being chemically incompatible with the lubricant;
a polymer-air interface defining the body;
a layer of lubricant at the polymer-air interface, the layer being replenished by lubricant migrating from within the body to the polymer-air interface so that the layer is kept at a substantially constant thickness.
